(19) United States
(12) Patent Application Publication
(10) Pub. No.: US 2002/0097329 A1
(43) Pub. Date: Jul. 25, 2002

(54) Active pixel sensor having separated voltage sources on reset transistor and other circuit

(76) Inventors: Meng-Chang Yang, Tainan City (TW); Chao-Kuei Chuang, Hsin-Chu City (TW)

Correspondence Address: BACON & THOMAS, PLLC, 625 Slaters Lane, 4th Floor, Alexandria, VA, 22314-1176, US

(21) Appl. No.: 09/843,823

(22) Filed: Apr. 30, 2001

(30) Foreign Application Priority Data
Jan. 19, 2001 (KR) 90201195

(51) Int. Cl. H04N 3/14

(52) U.S. Cl. 348/294

(57) ABSTRACT

An active pixel sensor comprises a first voltage source and a second voltage source. The first voltage source is provided to charge a photoelectric element. The second voltage source is provided to supply power to a source follower transistor, a read out switch transistor, and a bias transistor. The first voltage source and the second voltage source are different, such that the noise of voltage signal on the photoelectric diode can be processed individually, and the switching noise is small and can be processed easily. Moreover, the flexibility of the voltage variation can be increased, and the two voltage sources may be individually adjusted as desired.

### BACKGROUND OF THE INVENTION

1. Field of the Invention

The present invention relates to the field of active pixel sensors, and especially to an active pixel sensor which has separated voltage sources on a reset transistor and other circuit.

2. Description of Related Art

FIG. 4 shows the structure of a single pixel in an active pixel sensor provided by the conventional metal oxide semiconductor manufacturing process, wherein the power of the pixel 41 is supplied by a power source VCC. In operating the pixel, a reset signal ‘RESET’ is first applied to reset the pixel 41. After an exposure time period, a row driving signal is applied so as to read a voltage value representing the photoelectric signal form the output (Pixel Out) of the pixel. The readout voltage value is stored in a correlated double sampling (CDS) circuit 42. Subsequently, the pixel 41 is reset again and the reset voltage is stored in the correlated double sampling circuit 42. By subtracting the two readout voltages, a voltage difference resulted from radiating the pixel 41 can be obtained, which can be used to eliminate the fixed pattern noise (FPN) caused by the critical voltage variance due to unmatched conditions in the transistor manufacturing process of the pixel 41.

In the active pixel sensor produced by the conventional CMOS manufacturing process, a single voltage source VCC is used and is connected to a maximum voltage of the chip. In order to acquire a maximum light exposing area, one signal wire is generally used in the layout, which results in that the noises between chips will interfere with each other. Furthermore, since the voltage of the transistor is restricted to be a maximum voltage, the following two noises will be produced:

(1) Random noise on the external voltage source: This random noise is produced because the signal generated by the voltage generator is noisy. Furthermore, the thermal noise on the circuit also results in that the voltage supplied to the pixel has relatively large noise.

(2) Voltage drop or switching noise: When the transistor is conducted or switched, noise caused by voltage drop or switching is produced.

These two noises are varied with time. Therefore, even there is CDS provided in the post end of the circuit, these two noises can not be eliminated. Therefore, it is desirable to improve the conventional active sensor to mitigate and/or obviate the aforementioned problems.

### SUMMARY OF THE INVENTION

The object of the present invention is to provide an active pixel sensor having separated voltage sources on a reset transistor and other circuit for reducing the switching noise and enhancing the flexibility of voltage variation, and separately adjusting the two voltage sources as desired.

To achieve the object, there is provided an active pixel sensor, comprising: a first voltage source and a second voltage source; a reset transistor connected to the first voltage source; a photoelectric element connected to the reset transistor for being charged by the first voltage source when the reset transistor is turned on; and, a source follower transistor, a readout switch transistor, and a bias transistor connected in series and supplied with power from the second voltage source, the source follower transistor having a gate connected to a connection point between the reset transistor and the photoelectric element, the bias transistor establishing a predetermined bias for the source follower transistor, so as to read out a photoelectric signal from the connecting point when the readout switch transistor is turned on; wherein, the first voltage source and the second voltage source are different.

Other objects, advantages, and novel features of the invention will become more apparent from the following detailed description when taken in conjunction with the accompanying drawings.

### BRIEF DESCRIPTION OF THE DRAWINGS

FIG. 1 is a circuit diagram of the active pixel sensor having separated voltage sources on a reset transistor and other circuit in accordance with the present invention.

FIG. 2 shows a preferred circuit layout of the active pixel sensor having separated voltage sources on a reset transistor and other circuit in accordance with the present invention.

FIG. 3 shows another preferred circuit layout having separated voltage sources on a reset transistor and other circuit in accordance with the present invention.

FIG. 4 shows the structure of an active pixel sensor formed by conventional CMOS manufacturing process.

### DETAILED DESCRIPTION OF THE PREFERRED EMBODIMENT

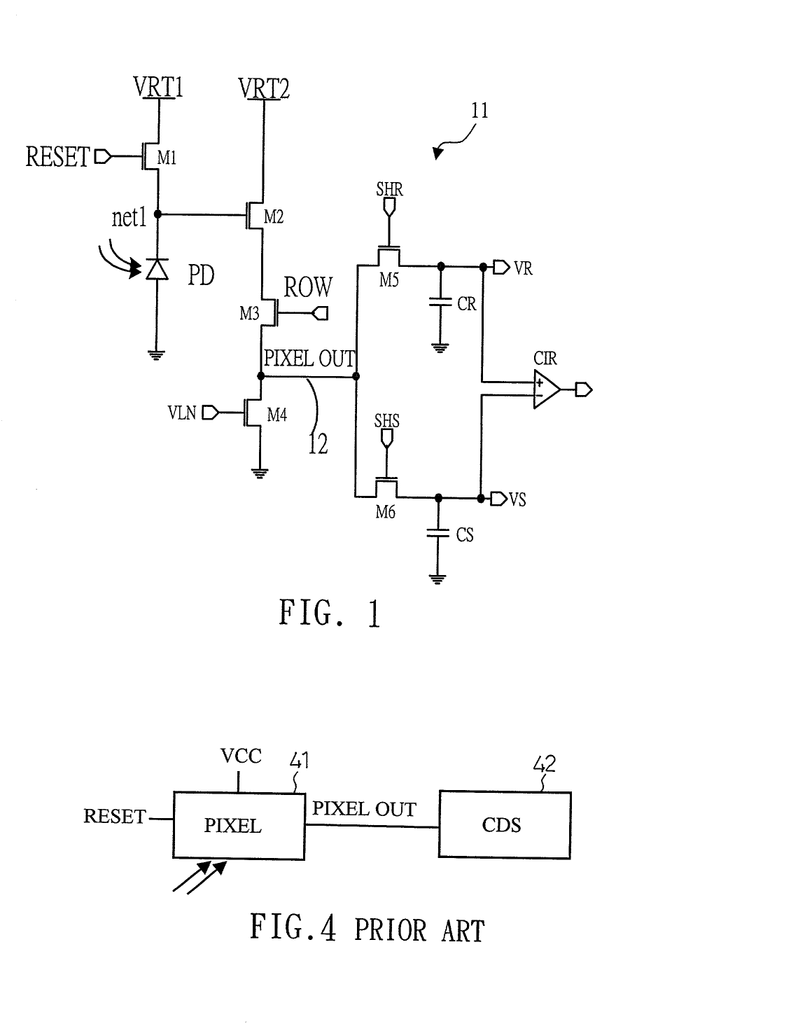

The active pixel sensor having separated voltage sources on a reset transistor and other circuit in accordance with the present invention is illustrated in FIG. 1. The circuit includes two different voltage sources VRT1 and VRT2, a photoelectric element which is, for example, a photoelectric diode PD, a reset transistor M1, a source follower transistor M2, a readout switch transistor M3 and a bias transistor M4. The aforesaid transistors are metal oxide semiconductors (MOS). The pixel out end 12 of the active pixel sensor is connected to a correlated double sampling circuit 11. The correlated double sampling circuit 11 is formed by transistors M5 and M6, capacitors CR and CS, and a subtracting circuit CIR. The transistors M5 and M6 are connected to the capacitors CR and CS, respectively, for controlling the charge to the capacitors CR and CS. The capacitors CR and CS are connected to the two inputs of the subtracting circuit CIR, which is formed by a differential amplifier.

The voltage source VRT1 is controlled by the reset transistor M1 so that, when the reset transistor M1 is turned on, the photoelectric diode PD connected to the reset transistor M1 is charged.

The voltage source VRT2 supplies power to the transistors M2, M3 and M4 connected in series. The gate of the source follower transistor M2 is connected to the connecting node, as denoted by net1, between the reset transistor M1 and the photoelectric diode PD. The readout switch transistor M3 is controlled by a row signal (ROW) on its gate to be turned on or off. The gate voltage VLN of the bias transistor M4 is retained in a constant value, so that, when the readout switch transistor M3 is turned on, a proper bias can be established for the source follower transistor M2.

In operating the aforesaid circuit, a reset signal, as denoted by ‘RESET’, is driven first to turn on the reset transistor M1 so as to reset the voltage of the photoelectric diode PD to the voltage Vcc of the node net1, and then the transistor M1 is turned off. Since the photoelectric diode PD is illuminated to generate photo current, the voltage of the node net1 is decreased. After a period of exposure time and before the voltage of the node net1 reaches a maximum measurable photo voltage, the read out switch transistor M3 is turned on for reading out photo current.

The photo voltage passes through the source follower transistor M2 and the output end 12 between the transistors M3 and M4 for being applied to the correlated double sampling circuit 11. At this moment, the transistor M6 is turned on so that the value of photoelectric signal is stored into the capacitor CS. Then, the readout switch transistor M3 is turned off and the voltage of the photoelectric diode PD is reset to Vcc again. The transistors M3 and M5 are turned on. The reset voltage is stored in the capacitor CR. The two values of the readout voltages are applied to the subtracting circuit CIR for performing a subtraction operation, so as to acquire a voltage difference due to the illumination of the photoelectric diode PD, wherein the voltage source VRT1 connected to the photoelectric diode PD is separated from the voltage source VRT2 connected to other circuit. The two voltage sources VRT1 and VRT2 are not necessary to be the highest voltage source in the chip. In the operating process, the value of the voltage source VRT2 can be changed according to the actual requirement without influencing the value of photoelectric signal on the photoelectric diode PD. The desired property of the circuit can be acquired by adjusting the values of the voltage sources VRT1 and VRT2.

With the sensor circuit of the present invention, since the voltage source VRT1 used for the photoelectric diode PD is separated from the voltage source VRT2 used for other circuit in the pixel, the noise of voltage signal on the photoelectric diode PD can be processed individually. Because the voltage source VRT1 only supplies the reset voltage to the photoelectric diode PD, the switching noise thereon is small and can be processed easily. Moreover, the voltage variations of the readout circuit and the source follower in the pixel will not directly affect the reset voltage of the photoelectric diode PD. Therefore, a signal that is unlikely to be interfered by noise is acquired on the photoelectric diode. In addition, since the two voltage sources VRT1 and VRT2 are supplied separately, the flexibility of voltage variation can be increased. The two voltage sources VRT1 and VRT2 can be adjusted individually so as to satisfy different requirements.

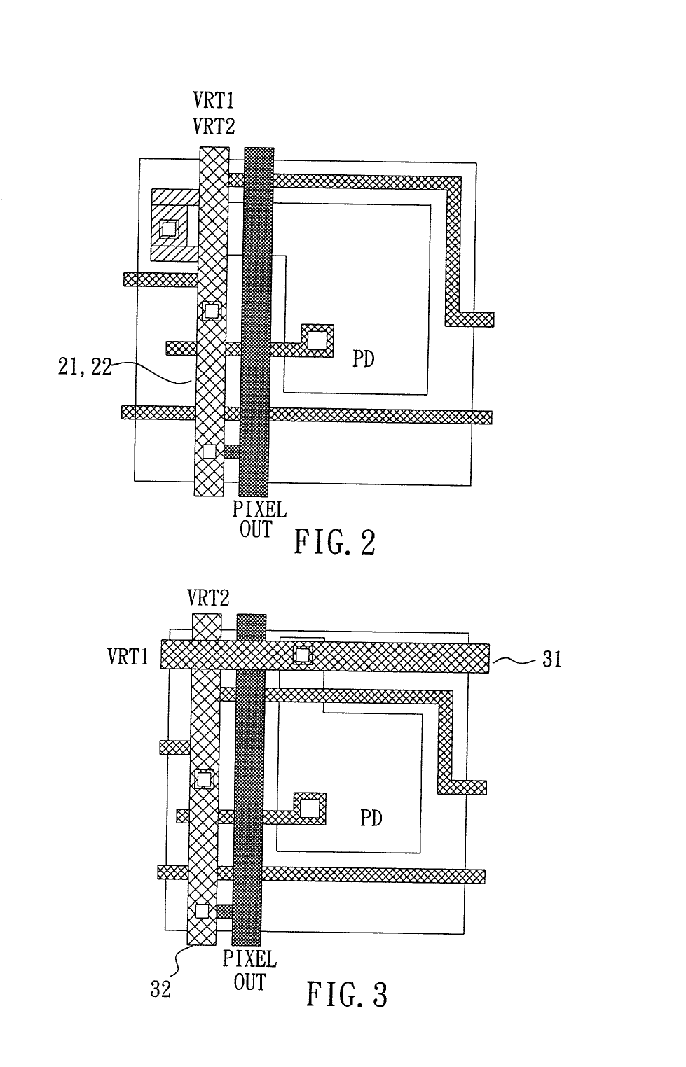

A preferred circuit layout of the aforesaid circuit is illustrated in FIG. 2, wherein, two layers of overlapped metal wires 21 and 22 are used to connect to the voltage sources VRT1 and VRT2, so that the metal wires of the two different voltage sources are used to supply voltages to the photoelectric diode PD and other circuits. In addition to eliminating the interference of noise, there is saved some space of pixel layout. FIG. 3 shows a second preferred circuit layout, wherein two layers of vertically arranged metal wires 31 and 32 are used to connect to the voltage source VRT1 and VRT2, so as to further reduce the mutual interference caused by the parasitic capacitor of the metal wires.

Although the present invention has been explained in relation to its preferred embodiment, it is to be understood that many other possible modifications and variations can be made without departing from the spirit and scope of the invention as hereinafter claimed.

What is claimed is:

1. An active pixel sensor comprising:
a first voltage source and a second voltage source;
a reset transistor connected to the first voltage source;
a photoelectric element connected to the reset transistor for being charged by the first voltage source when the reset transistor is turned on; and
a source follower transistor, a readout switch transistor, and a bias transistor connected in series and supplied with power from the second voltage source, the source follower transistor having a gate connected to a connection point between the reset transistor and the photoelectric element, the bias transistor establishing a predetermined bias for the source follower transistor, so as to read out a photoelectric signal from the connecting point when the readout switch transistor is turned on;
wherein, the first voltage source and the second voltage source are different.

2. The active pixel sensor as claimed in claim 1, wherein the first and second voltage sources are connected to two layers of overlapped metal wires, respectively, for supplying voltages to a pixel, thereby eliminating noise interference and saving layout space.

3. The active pixel sensor as claimed in claim 1, wherein the first and second voltage sources are connected to two layers of vertically arranged metal wires, respectively, for supplying voltages to a pixel, thereby avoiding noise interference causes by parasitic capacitors of the metal wires.

4. The active pixel sensor as claimed in claim 1, wherein the first and said second voltage sources can be adjusted when the active pixel sensor is operating.

5. The active pixel sensor as claimed in claim 4, wherein the pixel sensor has an output end connected to a correlated double sampling circuit.
